(19) United States
(12) Patent Application Publication
(10) Pub. No.: US 2013/0244216 A1
(43) Pub. Date: Sep. 19, 2013

(54) Pop-up Content for Figurative Expressions and Complementary Related Trivia

(71) Applicant: Lee Michael DeGross, Fort Lee, NJ (US)

(72) Inventor: Lee Michael DeGross, Fort Lee, NJ (US)

(21) Appl. No.: 13/797,975

(22) Filed: Mar. 12, 2013

Related U.S. Application Data
(60) Provisional application No. 61/632,831, filed on Mar. 13, 2012.

(51) Int. Cl. G09B 5/02

(52) U.S. Cl. CPC G09B 5/02
USPC 434/322

(57) ABSTRACT

An educational and fun computer process in which a user selects a figurative expression displayed on a screen. The figurative expressions are, for example, metaphors, allusions, puns, double entendres, anagrams, cropped terms, and other nonliteral terms. A pop-up space instantly appears that presents educational content about the figurative expression. A complementary related trivia is presented in various possible formats to enliven the learning experience. The complementary trivia can be related to the figurative expression, or the associated information displayed on the screen, or the educational content, or the trivia itself. The educational content can be, for example, meanings, reference materials, literary reviews, interpretations, and images or moving images. The reference materials are, for example, dictionary entries like definitions, senses, parts of speech, antonyms, and etymologies. The educational features are options used to help a person learn about figurative expressions, and the entertaining trivia is there to be enjoyed.

### CROSS-REFERENCE TO RELATED APPLICATIONS

This application claims the benefit of provisional patent application Ser. No. 61/632,831, filed 2012 Mar. 13, and provisional patent application Ser. No. 61/635,871, filed 2012 Apr. 20 by the present inventor.

### FEDERALLY SPONSORED RESEARCH

Not applicable

### SEQUENCE LISTING OR PROGRAM

Not applicable

### BACKGROUND

1. Field

This application relates to the field of computers, specifically to educational digital multimedia processes.

2. Prior Art

The less relevant prior art will be discussed first and will progress to the more significant prior art. For purposes of brevity, the word “selection”, “selecting”, “selects”, and “selected” encompasses all of the various selection methods of a computer. These selection methods include stylus, keyboard, mouse click, touchscreen, and other selection tools.

Pop-up spaces are frequently encountered when using computer software applications. Many functions in software are represented by a graphical icon meant to make it easy to recognize its meaning. For example, in Microsoft Word™, a popular word processor program, when the cursor is placed over the yellow folder icon, the word “Open” pops up next to it.

More examples of pop-ups from Microsoft Word™ includes the brush icon which results in the “Format Painter” pop-up, the italicized “ABC” icon with a checkmark which results in the “Spelling and Grammar” pop-up, and the “can of spilling paint” icon which results in the “Fill Color” pop-up.

A major reason these pop-ups are used is to save space. These pop-ups are minor prior art. The limitations of these pop-ups are obvious. They merely serve as a labeling technique for the icons. The pop-ups do not present the meanings of figurative expressions such as a metaphor or an abbreviation that are typically displayed within a text.

The next prior art is the thesaurus function of Microsoft Word™, currently the dominant word processor. First a word must be selected by having the cursor within it or highlighting it. The fastest sequence requires a right-click, which yields a pop-up menu having a “Synonyms” choice, and after it is selected a synonyms list is shown.

A disadvantage of the fastest thesaurus function is its slowness and unwieldiness. At least three selecting actions are needed to find the synonyms for a word. The pop-up menu is unwieldy because it has 11 other choices and most are word processing functions.

The next prior art is the dictionary function of Microsoft Word™. The fastest sequence requires selecting a word, the right-click, which yields a pop-up menu having a “Look Up . . . ” choice, and causes the tall research column to appear top to bottom outside of the word processor page, layout, or window. The column has an input box for entering words, a drop-down menu requiring a selection of various dictionary and thesaurus titles (the other selections are a translation feature and various research, business, and financial sites), selecting the “Encarta Dictionary: English (North America) choice, and showing the dictionary information for the selected word.

A disadvantage of the dictionary function is its slowness and unwieldiness. At least four selecting actions are needed to find the dictionary information for a word. The pop-up menu is unwieldy because it has 11 other choices and most are word processing functions. Another disadvantage is the absence of a pop-up space with the dictionary information near the selected word.

The last described disadvantage of Microsoft Word™ is the absence of a dictionary for figurative expressions.

The next prior art is the method used by software applications, such as a website, to provide the meanings of figurative expressions. There are websites with URL addresses of www.abbreviations.com, www.acronymfinder.com, www.acronyms.thefreedictionary.com, and www.merriam-webster.com/dictionary/abbreviation.

Each website requires the user to enter the figurative expression into an input box. Then the user must select “enter”, “return”, “search”, or a similar function to initiate the search. The results are displayed on the same website window as the input box. The disadvantage of these websites is the absence of providing the results in a pop-up space.

The website www.medilexicon.com also requires the user to enter the medical figurative expression into a search box. The user must next select the “Go!” button to get the results. The website provides the results in a pop-up window. The disadvantage is that the website uses a search box method only.

The disadvantages of these websites are twofold. The first necessity is the step of entering the figurative expressions, such as by typing, into an input box. The second necessity is the step of selecting, for example, “enter” or “Go!” to initiate the search. This is inferior to simply selecting the figurative expressions without the need for the two steps.

The next prior art is U.S. Pat. No. 6,966,030 entitled “Method, system and computer program product for implementing acronym assistance”. A writer or reader uses its method to select an acronym in a text document which is scanned for the definition or expanded form of the acronym. If the definition is found, options are provided for the user to select, such as to display the acronym definition in bubble text. Other options are to take the user to the document location where the acronym is defined and then back, or to automatically display the acronym's expanded form within the text or as a footnote.

If the acronym definition is not found, an independent acronym dictionary or an independent collection of acronym usages is utilized. The user can view the acronym definitions in a bubble or jump to the separate acronym dictionary and then back. The user selects an acronym definition or is helped by recommendations from the acronym assistance program. Next the user selects the options as described above.

The next prior art is U.S. patent application Ser. No. 11/339,155 entitled “Automatic acronym expansion using pop-ups” which has the same assignee as the above patent. The method has an electronic communication text that displays an acronym. A user selects an acronym which automatically presents a pop-up. The pop-up can include repeating text of the acronym, an expansion of the selected acronym, enabling the user to alter configurable acronym expansion settings, and acronyms defined by a participant other than the user. The method utilizes a user configurable acronym definition table and user customizable acronym expansion repositories.

A disadvantage of the above patent and patent application is that both are limited only to acronyms. They provide no results for other nonliteral expressions like abbreviations, initials, cropped terms, anagrams, metaphors, figures of speech, allusions, puns, slangs, or double entendres.

Both fail to provide educational information in their bubble text or pop-up such as reference materials and entries, reviews, narratives, criticisms, historical information, symbolic significances, interpretations, themes, connotations, persons, people, and images and moving images.

Their features of “definition” and “defined” are equivalent to the acronym expansions. The features are not used in the dictionary definitions sense to define words.

In fact both describe no educational or learning purpose. The patent's acronym assistance is limited only to acronyms. Even with the recommendations, a disadvantage is that the acronym assistance leaves room for some guesswork. The patent application does not have the acronym assistance function. Its purpose is for 1 or 2 way communications, and particularly for 2 way text messages.

Both fail to provide any sound effects such as for the pronunciation of the acronym definition or expansion.

A disadvantage of each of the above prior art references is that they do not provide any fun trivia to enliven the learning experience.

The next prior art is called “SuperMunchers Trivia” which is available on a CD-ROM. This computer trivia game combines arcade action and trivia questions. Players must control their Munchers and munch the answer to questions while evading Troggles, who can eat the Munchers. A player's trivia knowledge is tested by munching as many answers as it can. The disadvantage is that the trivia game does not have any educational content such as dictionary entries.

The next prior art are the patents and patent applications about different computer trivia versions which are listed in the attached Information Disclosure Statement. The disadvantage of these trivia versions is that none describe or teach what a figurative expression means. Another disadvantage is that none describe or teach presenting any dictionary entries.

This concludes the prior art section.

### SUMMARY

A process that starts when a human selects a figurative expression displayed on a computer screen. The examples of figurative expressions are metaphors, allusions, figures of speech, puns, slangs, anagrams, and cropped terms such as abbreviations. A convenient pop-up space instantly appears nearby that presents an educational content for the selected figurative expression and a complementary related trivia. The examples of the educational content are meanings, what a cropped term stands for, commentaries, criticisms, interpretations, and reference materials such as dictionary entries. The pop-up content can contain images and moving images. The complementary trivia can be related, for example, to the selected figurative expression or the pop-up contents, and can be presented in many possible formats. The process provides learning, informative, and fun benefits.

### DRAWINGS

### Figures

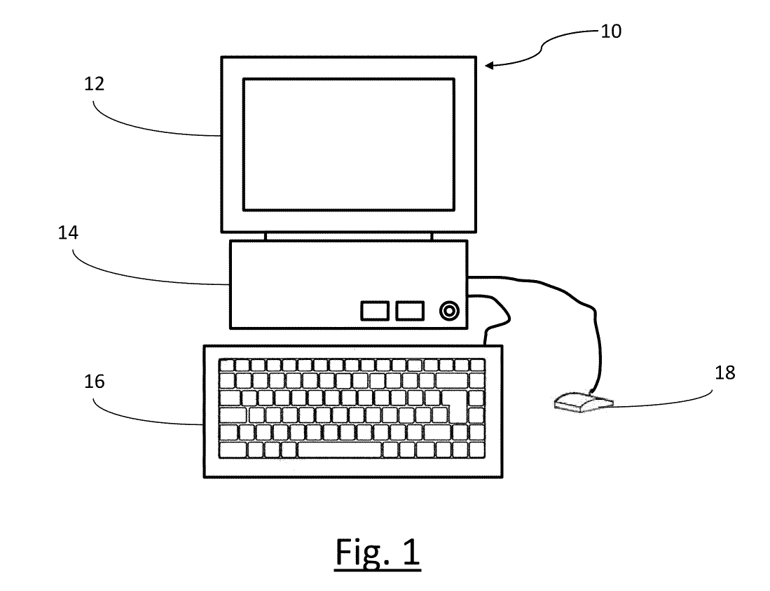

FIG. 1 shows a computer.

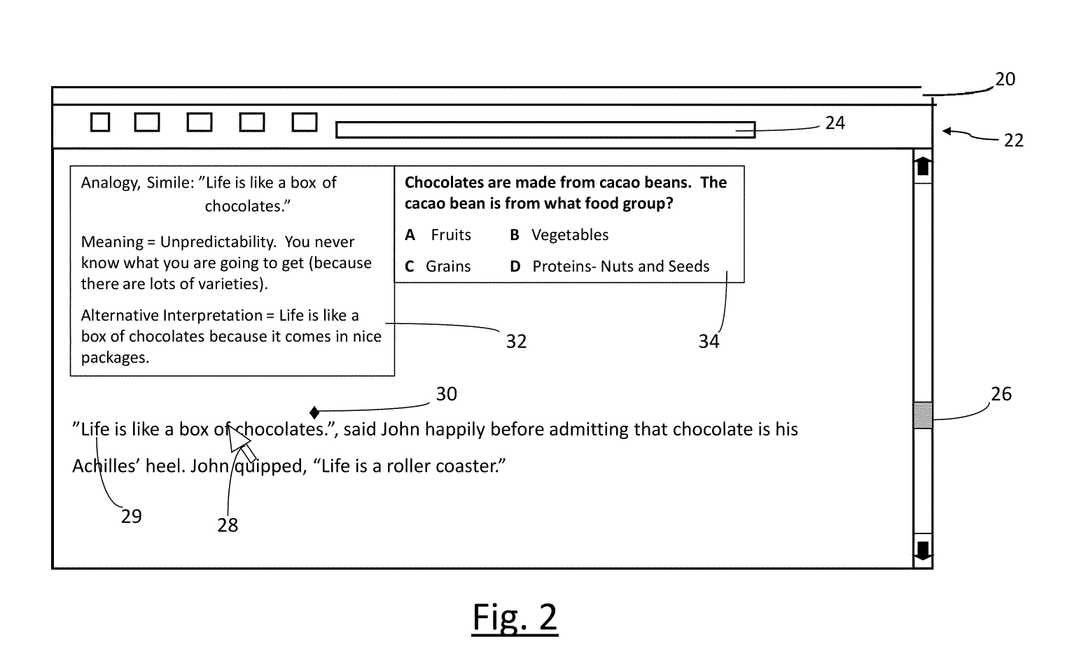

FIG. 2 shows web browser features with a cursor selecting a signaled figurative expression of “Life is like a box of chocolates” which is an analogy or simile. A pop-up educational content and a complementary related trivia appears.

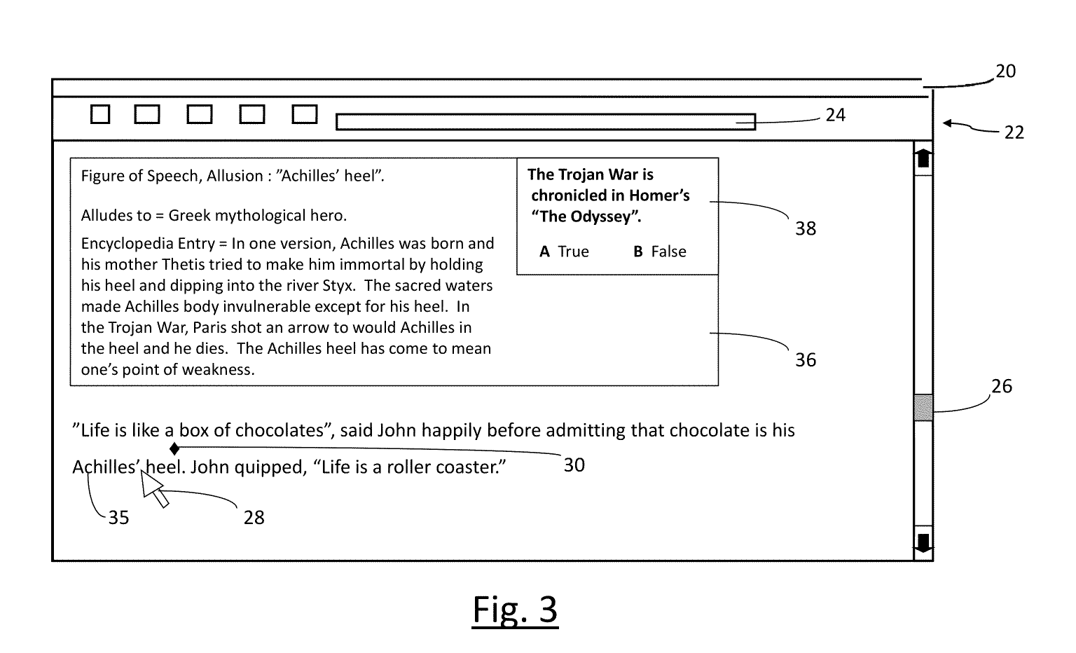

FIG. 3 shows a selected signaled figure of speech or allusion of “Achilles' heel”. A pop-up educational content and a complementary related trivia appears.

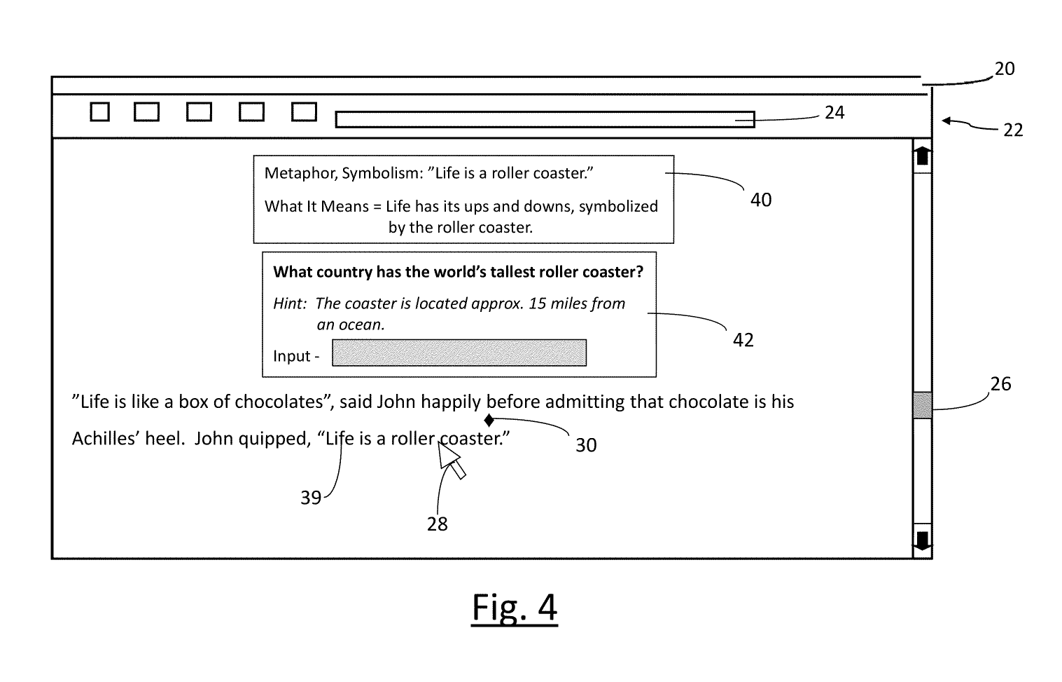

FIG. 4 shows a selected signaled metaphor or symbolism of “Life is a roller coaster.” A pop-up educational content and a complementary related trivia appears.

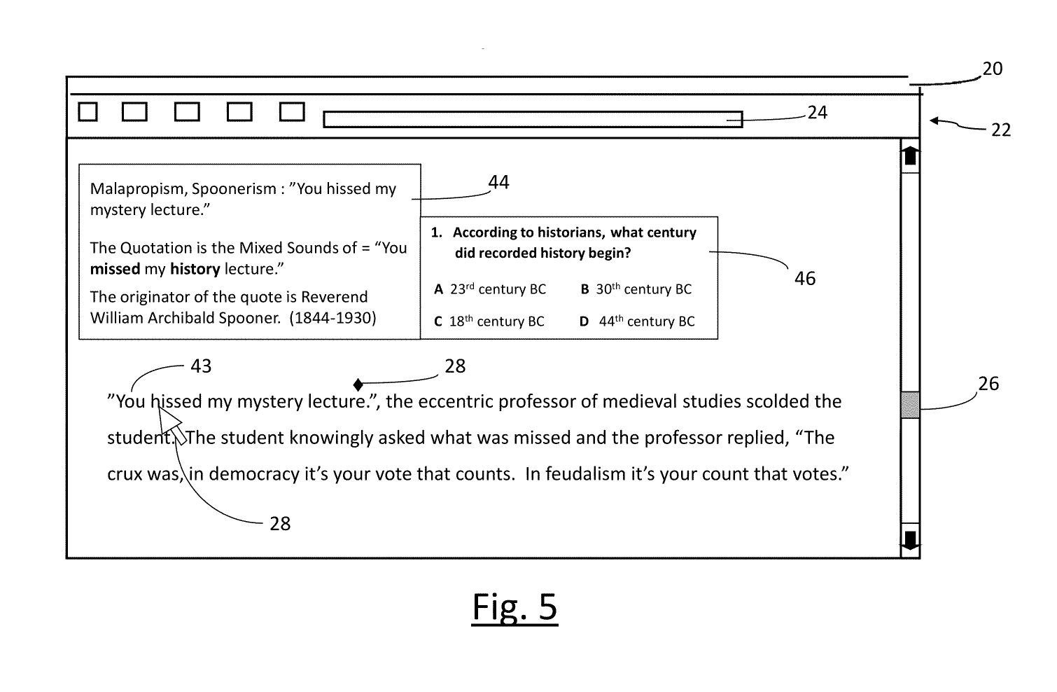

FIG. 5 shows a selected signaled malapropism or spoonerism of “You hissed my mystery lecture.” A pop-up educational content and a complementary related trivia appears.

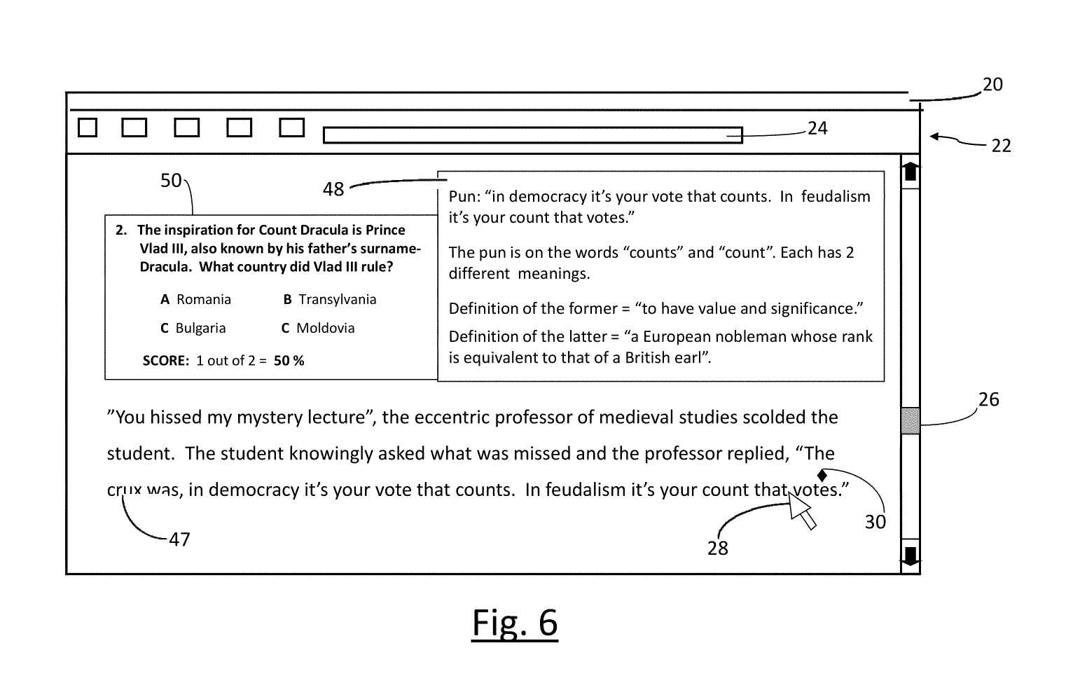

FIG. 6 shows a selected signaled pun of “The crux was, in democracy it's your vote that counts. In feudalism it's your count that votes.” A pop-up educational content and a complementary related trivia appears.

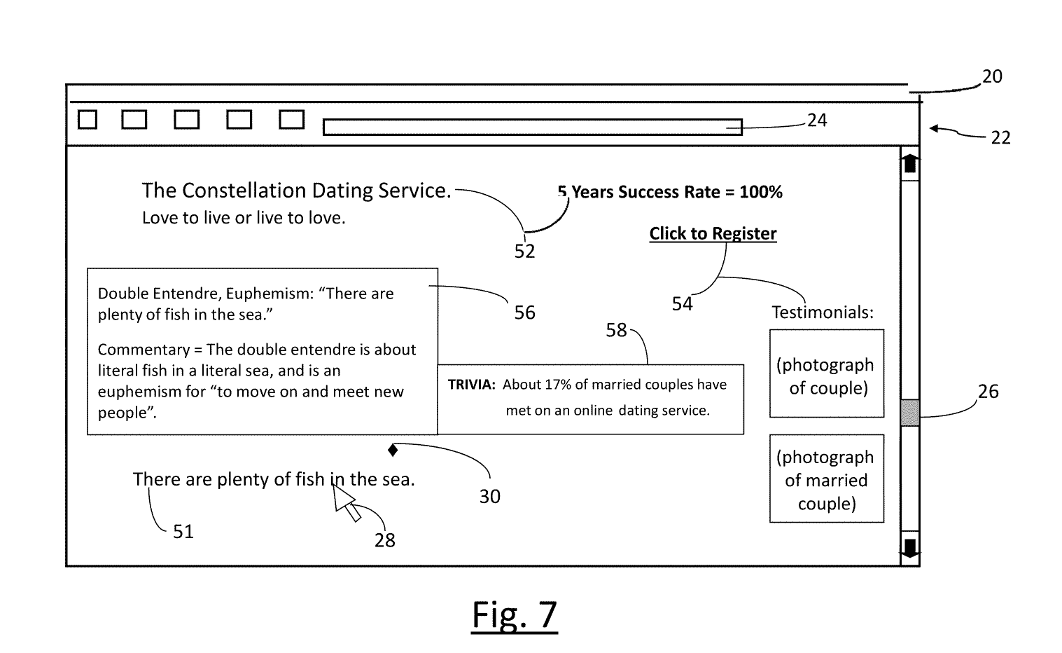

FIG. 7 shows various associated information next to, a selected signaled double entendre or euphemism of “There are plenty of fish in the sea.” A pop-up educational content and a complementary related trivia appears.

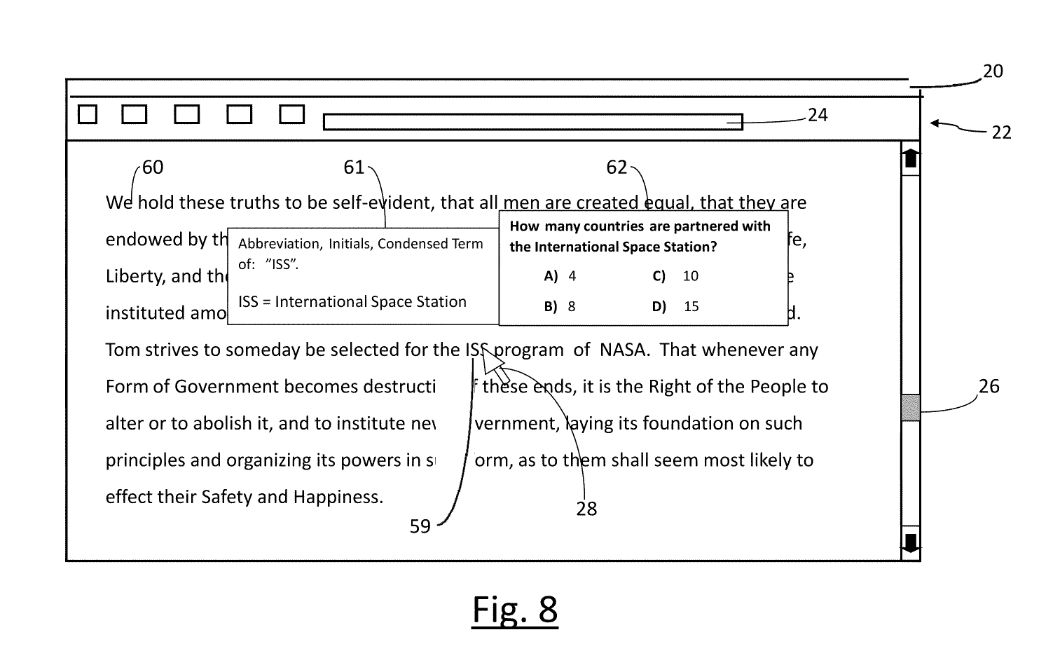

FIG. 8 shows a selected abbreviation, initials, or condensed term of “ISS”. A pop-up educational content and a complementary related trivia appears.

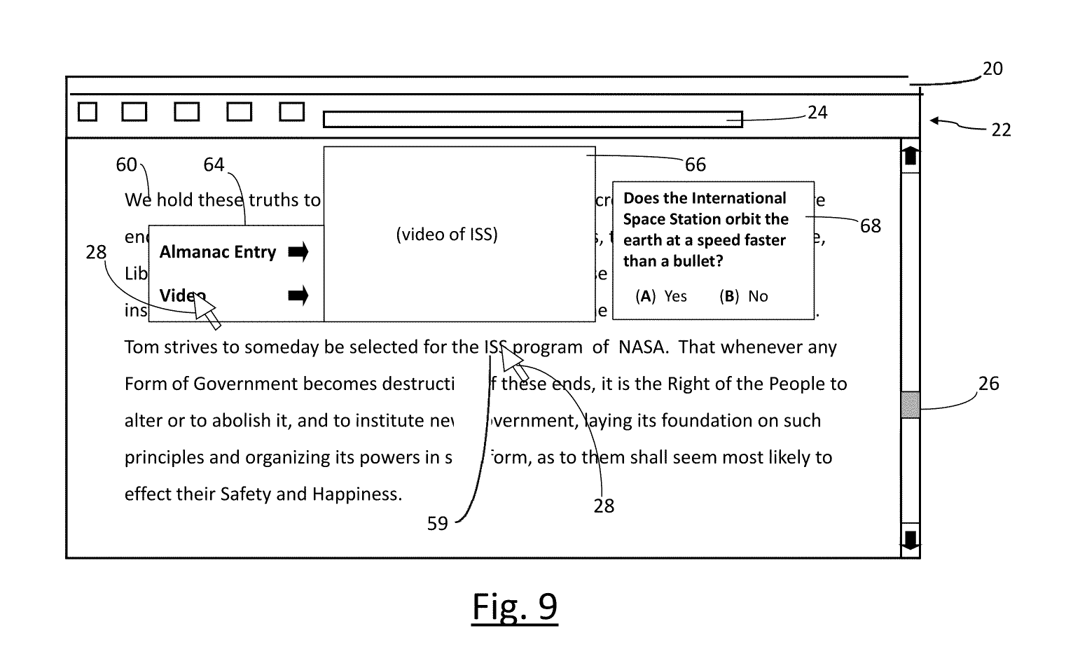

FIG. 9 shows the same selected figurative expression of FIG. 8. A pop-up space having a menu with 2 choices appears. The video choice is next selected and a pop-up educational content and a complementary related trivia appears.

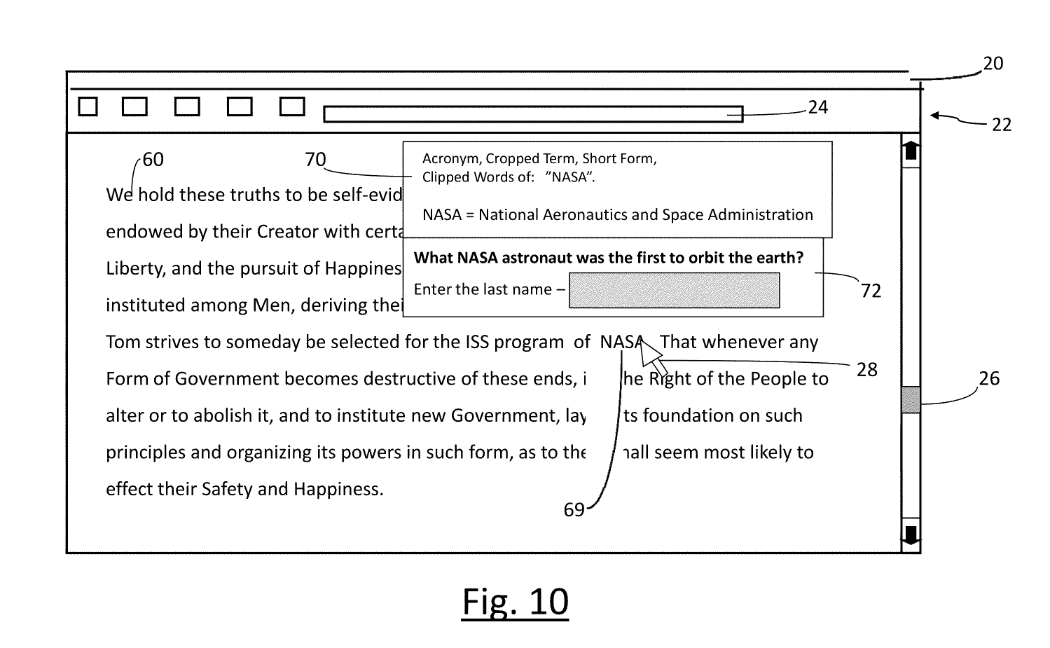

FIG. 10 shows a selected acronym, cropped term, short form, or clipped words of “NASA”. A pop-up educational content and a complementary related trivia appears.

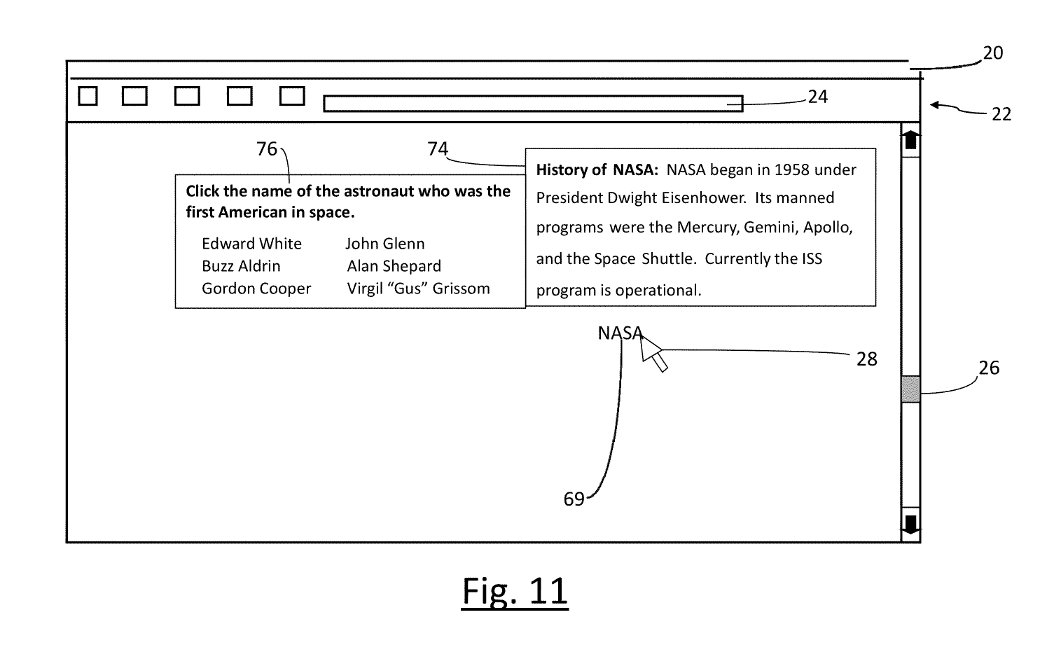

FIG. 11 shows the same selected figurative expression of FIG. 10, without being within a text. A pop-up educational content and a complementary related trivia appears.

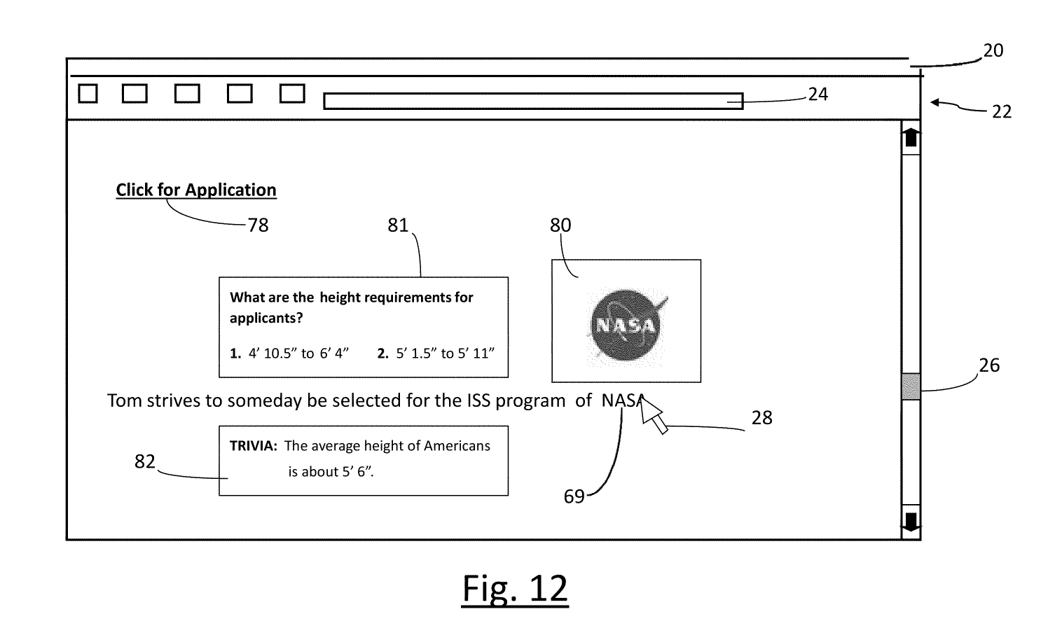

FIG. 12 shows an associated information next to the same selected figurative expression of FIG. 10. A pop-up educational content and a complementary related trivia appears.

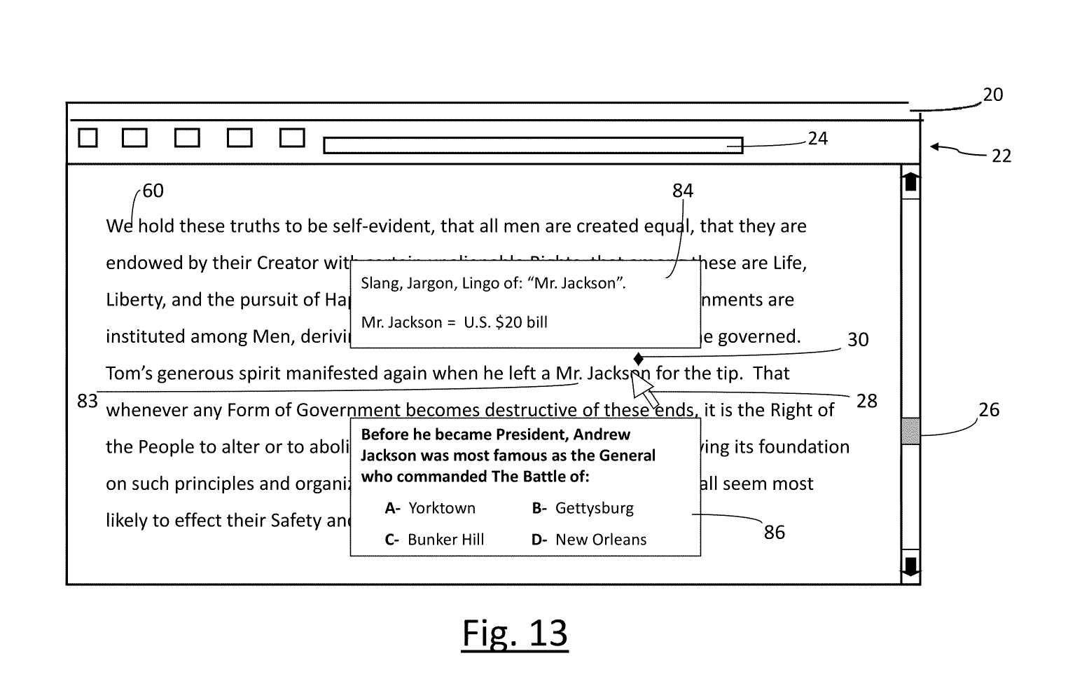

FIG. 13 shows a selected signaled slang, jargon, lingo term of “Mr. Jackson”. A pop-up educational content and a complementary related trivia appears.

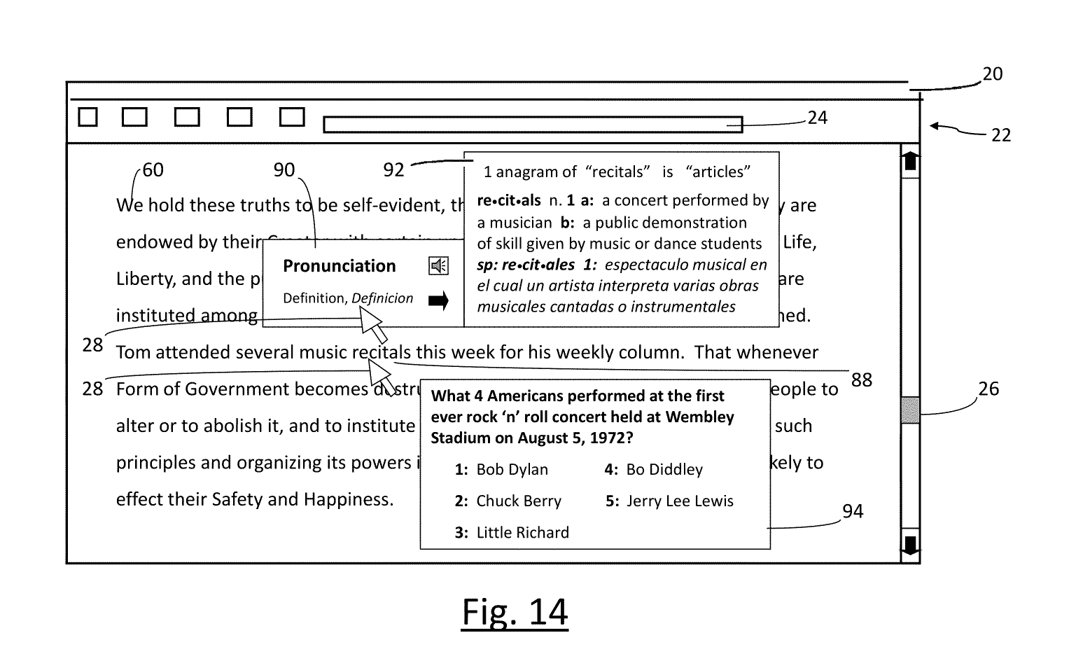

FIG. 14 shows a selected anagram of “recitals”. A pop-up space having a menu with 2 choices appears. The “definition, definicion” choice is next selected and a pop-up educational content and a complementary related trivia appears.

### REFERENCE NUMERALS

| | | |
|---|---|---|
| 10 | computer | 12 screen |
| 14 | central processing unit | 16 keyboard |
| 18 | mouse | 20 operating system bar |
| 22 | web browser features | 24 Uniform Resource Locator field |
| 26 | scroll bar | 28 cursor |

| | |
|---|---|
| 29 | analogy or simile in “Life is like a box of chocolates.” |
| 30 | special distinguishing signal |
| 32 | pop-up content presenting “Analogy, Simile: “Life is like a box of chocolates.”, |
| | “Meaning = Unpredictability. You never know what you are going to get (because |
| | there are lots of varieties).”, and “Alternative Interpretation = Life is like a box of |
| | chocolates because it comes in nice packages.” |
| 34 | pop-up content presents an interactive complementary trivia related to the |
| | “chocolates” in the selected part 29, in a question and multiple choice format |
| 35 | figure of speech or allusion in “Achilles' heel” |
| 36 | pop-up content presenting “Figure of speech, Allusion: “Achilles' heel”., “Alludes |
| | to = Greek mythological hero.”, and “Encyclopedia Entry = In one version, Achilles |
| | was born and his mother Thetis tried to make him immortal by holding his heel |
| | and dipping into the river Styx. The sacred waters made Achilles body |
| | invulnerable except for his heel. In the Trojan War, Paris shot an arrow to would |
| | Achilles in the heel and he dies. The Achilles heel has come to mean one's point |
| | of weakness.” |
| 38 | complementary trivia, presented in the pop-up content of part 36, that is related |
| | to the “Trojan War” in the pop-up content of part 36, in a sentence and true or |
| | false format |
| 39 | metaphor or symbolism in “Life is a roller coaster.” |
| 40 | pop-up content presenting “Metaphor, Symbolism: “Life is a roller coaster.” and |
| | “What It Means = Life has its ups and downs, symbolized by the roller coaster.” |
| 42 | pop-up content, that is presented outside of the pop-up content of part 40, |
| | presents a complementary trivia related to the “roller coaster” in the selected |
| | part 39, in a question with a hint and an input field format |
| 43 | malapropism or spoonerism in “You hissed my mystery lecture.” |
| 44 | pop-up content presenting “Malapropism, Spoonerism: “You hissed my mystery |
| | lecture.”, “The Quotation is the Mixed Sounds of = “You missed my history |
| | lecture.””, and “The originator of the quote is Reverend William Archibald |
| | Spooner. (1844-1930)” |
| 46 | pop-up content presents a complementary trivia related to the “history” in the |
| | pop-up content of part 44, in the first of a serial format |
| 47 | pun in “The crux was, in democracy it's your vote that counts. In feudalism it's |
| | your count that votes.” |
| 48 | pop-up content presenting “Pun: “in democracy it's your vote that counts. In |
| | feudalism it's your count that votes.””, “The pun is on the words “counts” and |
| | “count”. Each has 2 different meanings.”, “Definition of the former = “to have |
| | value and significance.””, and “Definition of the latter = “a European nobleman |
| | whose rank is equivalent to that of a British earl”.” |
| 50 | pop-up content presents a complementary trivia related to the “count” in the |
| | selected part 47, in the second of the serial format and a score result |
| 51 | double entendre or euphemism in “There are plenty of fish in the sea.” |
| 52 | three types of associated information next to part 51 of a name, sentence, and a |
| | statistic |
| 54 | two more types of associated information next to part 51 of a link to register and |
| | photographs |
| 56 | pop-up content presenting “Double Entendre, Euphemism: “There are plenty of |
| | fish in the sea.”” and “Commentary = The double entendre is about literal fish in |
| | a literal sea, and is an euphemism for “to move on and meet new people”.” |
| 58 | pop-up content presents a complementary trivia related to the “Dating Service” |
| | in the associated information of part 52, in a non-interactive format |
| 59 | abbreviation, initials, or condensed term in “ISS” |
| 60 | pop-up content presenting “Abbreviation, Initials, or Condensed Term of: “ISS”.” |
| | and what part 59 stands for in “ISS = International Space Station” |
| 60 | text on the screen |
| 61 | pop-up content presents a complementary trivia related to the “International |
| | Space Station” in the pop-up content of part 60, in a question and multiple |
| | choice format |
| 64 | pop-up space having a menu with the 2 choices of almanac entry and video, and |
| | the video choice is selected |
| 66 | pop-up content containing a video moving image as indicated by “(video of ISS)” |
| 68 | pop-up content presents a complementary trivia related to the “(video of ISS)” in |
| | the pop-up content of part 66, in a statement and yes or no format |
| 69 | acronym, cropped term, short form, or clipped term in “NASA” |
| 70 | pop-up content presenting “Acronym, Cropped Term, Short Form, Clipped Words |
| | of: “NASA”.” and spells out part 69 in “NASA = National Aeronautics and |
| | Space Administration” |
| 72 | pop-up content presents a complementary trivia related to the “NASA” in the |
| | pop-up content of part 70, in a question and input field format |
| 74 | pop-up content presenting “History of NASA: NASA began in 1958 under |
| | President Dwight Eisenhower. Its manned programs were the Mercury, Gemini, |
| | Apollo, and the Space Shuttle. Currently the ISS program is operational.”, that is |
| | from an extemporaneous work source. |
| 76 | pop-up content presents a complementary trivia related to the “NASA” in the |
| | selected part 69, in an instruction and multiple choice format |
| 78 | associated information next to part 69 of a link for application |
| 80 | pop-up content containing a picture image of the NASA logo |
| 81 | pop-up content presents a complementary trivia related to the “Application” in |
| | the associated information of part 78, in a question and multiple choice format |
| 82 | pop-up content presents a complementary trivia related to the “height” in the |
| | complementary trivia of part 81, in a format that does not require a response |
| 83 | slang, jargon, or lingo in “Mr. Jackson” |
| 84 | pop-up content presenting “Slang, Jargon, Lingo of: “Mr. Jackson”.” and what |
| | part 83 represents in “Mr. Jackson = U.S. $20 bill” |
| 86 | pop-up content presents a complementary trivia related to the “Mr. Jackson” in |
| | the selected part 83, in a incomplete sentence and multiple choice format |
| 88 | 1 anagram in “recitals” |
| 90 | pop-up space having a menu with the 2 choices of pronunciation with speaker |
| | icon and Definition, Definicion, and the Definition, Definicion choice is selected |
| 92 | pop-up content presenting “1 anagram of “recitals” is “articles”” and “re•cit•als |
| | n. 1 a: a concert performed by a musician b: a public demonstration of skill |
| | given by music or dance students sp: re•cit•ales 1: espectaculo musical en el |
| | cual un artista interpreta varias obras musicales cantadas o instrumentals” |
| 94 | pop-up content presents a complementary trivia related to the “concert” in |
| | the pop-up content of part 92, in a question asking for 4 answers and multiple |
| | choice format in which 4 out of 5 are correct answers |

### DETAILED DESCRIPTION

### First Embodiment

The title of this application, “Pop-up Content for Figurative Expressions and Complementary Related Trivia” is hereinafter abbreviated, “Content for Figurative and Trivia”. The Content for Figurative and Trivia is a computer and internet creation that is a process, method, and a system. The process is for enabling an educational, learning, and informational result about a figurative expression utilizing a selection method and a pop-up space. The stimulating, complementary related trivia is also presented. The process is fast, convenient, and fun for a person to use.

First a static physical description of a computer and the internet will be discussed. The computer is an ubiquitous machine that has undergone constant changes in form, speed, and memory size and this will continue as computers evolve presently and in the future. Computers come in all shapes and sizes but share four essential characteristics consisting of the digital input, processing, memory, and output functions.

Computers range in size from small hand-size personal digital assistants (PDA's) to a briefcase-like laptop PC (personal computer) to a typical desktop PC (personal computer). Larger computers like workstations and mainframes do not count for the Content for Figurative and Trivia because their size is inappropriate for the intended audience of everyday computer and internet users.

The selection methods of the computer include and are not limited to a keyboard, mouse, touchscreen, touchpad, touch-button, stylus, and voice recognition. Two of the fastest selection methods are placing the cursor over the figurative expression without clicking it, or using the touchscreen method without a stylus.

The largest computer category (the desktop) will be described first and continue downwards in size to the PDA's. The categories mentioned are the prevalent ones and the computer is not limited to those described.

The desktop PC (or microcomputer) looks like a television screen sitting atop a square-looking slab about the size of a small suitcase. The television screen is actually a computer monitor and its screen is the primary output device. The screen shows multimedia text and images. The slab-like box, known as the Central Processing Unit (CPU), houses the processing and memory devices. It is often placed for example somewhere else on the desk or on the floor.

Positioned in front of the monitor or CPU is a flat slab with many buttons called a keyboard. The keyboard is an input device that that is used for typing to enter letters, numbers, characters, other symbols, and for maneuvering on the screen.

The mouse is another input device commonly used with desktop computers and is usually the size of a person's palm. The mouse is placed on a flat surface like a desk so that when a user moves it, the pointer or cursor on the screen moves correspondingly. The mouse often has a few buttons and other features. These features are a means, for example, for the pointer or cursor to draw, insert, point, select, choose, and “click on” a particular spot on the screen.

The last major desktop device, the printer (not shown), is an output device that comes in all shapes, sizes, and types. The average printer is typically a laser printer shaped like a medium-sized moving box. The printer's function, as the name implies, is to print or produce the hard copy (paper) output of the computer. The printer, though not essential to the Content for Figurative and Trivia, is included for the sake of thoroughness.

The laptop (not shown), by now a very common machine, combines all of the features and devices of the desktop PC system (with the current exception of a printer) into one single unit. It is typically the size of a large notebook. Laptops are designed to be a portable PC with a very thin monitor and screen that, when closed, is usually positioned face down on the keyboard. A hinge or other similar device typically combines the keyboard and monitor, and the laptop looks like an open clamshell when opened.

Tablets (not shown) and the similar ereaders have the portability of laptops but are smaller with their screens taking up almost all their physical frames. They are typically extremely thin, many are less than an inch thick, and are more or less 9 square inches in size in a rectangular shape. The devices may have a cover or even a clamshell cover but the majority do not. Many tablets and ereaders use the touchscreen as the primary selection method. Tablets use most of the same software and internet applications as the desktop and laptop. Ereaders are for reading electronic books or ebooks, and most tablets also have this capability. Many ereaders use other software and internet applications. Tablets and ereaders often have special software tailored to their unique screen dominated shape and small light size. For example, the screen contents can easily switch 90 degrees to a total of 360 degrees, and easily slide to the next window or ebook page.

Personal digital assistants (PDA's) (not shown) are portable devices designed to be small enough to fit in a human's hand or shirt pocket. Many PDA's are pen-based, meaning that a pen-like stylus is used to do the input functions of the keyboard and mouse by touching the PDA's monitor. PDA's often have organizing functions that allow a person to do scheduling, act like a notepad, store information, calculate, and use many software applications for many other uses.

PDA's, including the tablets and ereaders, can be combined with various other electronic gadgets (not shown) that includes and is not limited to cell phones, pagers, gaming devices, GPS devices, and the like. Cell phones are portable wireless telephones. Pagers are small devices that alert the person to return a call, or receive and send a message. Gaming devices are handhelds that play computer games of all kinds. GPS devices are global positioning systems that provide advanced navigation, location, and mapping features. Any PDA that exhibits multimedia text and images is relevant to the Content for Figurative and Trivia.

For PDA's accessing an internet website, the screen typically shows just a portion of the website. The PDA's screen can get the rest of the website by using a scrolling function to go across, or up and down. The PDA's monitor can even display 100% of a website's contents on its small screen. PDA's, including tablets and ereaders, can show a digital keyboard on their screens for inputting functions.

Some desktops, laptops, tablets, ereaders, and PDA's are segments of a broader computer system because they have one or more limited or partial computer components (not shown). The segments can entirely lack the one or more computer components. The components includes and is not limited to hard drives, CPUs, monitors, screens, memories, keyboards, batteries, and internet connectivity.

Some desktops, laptops, tablets, ereaders, and PDA's can have detachable components (not shown) such as a screen. The detached component can be attached to another computer.

All of the computer categories can have peripheral devices (not shown). The peripheral devices includes and is not limited to extra monitors, extra screens, external hard drives, internal hard drives, CD and DVD drives, CDs, DVDs, speakers, portable audio and video recorders, portable PDA and handheld devices, cameras, video projectors, televisions, game devices, flash drives, flash cards, credit and debit card machines, and even cash registers.

Virtually all desktops, laptops, tablets, ereaders, and PDA's can access the internet and an intranet, often by wireless means. The computers are powered using an electrical outlet, sometimes in combination with batteries which are usually rechargeable, or only the batteries.

The internet and the intranet will now be described. The idea of the internet is simple, a vast network of computers of many types that are connected and interact with one another. The whole of the internet could probably be written about in a series of large books.

The following definition of the internet is from the IBM Dictionary of Computing. It defines the internet as, “A wide area network connecting thousands of disparate networks in industry, education, government, and research. The Internet network uses TCP/IP as the standard for transmitting information.”

The TCP/IP is defined by the same dictionary as, “Transmission Control Protocol/Internet Protocol. A set of communication protocols that support peer-to-peer connectivity functions for both local and wide area networks.”

The internet spans many countries, consists of thousands of networks, has millions of users, and will continue to grow and improve. The most relevant feature regarding the internet is the World Wide Web (WWW), with its ability to handle graphics, multimedia, and hypertext links.

The WWW is navigated or surfed with the help of a web browser. A website's address is accessed when its URL (Uniform Resource Locator) or domain name is invoked on the browser's domain name locator. For WWW websites, their address begins with the prefix “www” as in www.websitenamecorn. The suffix “.com” is a government-created categorization representing the commercial industry. Other examples of these suffixes are “.net”, “.org”, “.edu”, “.mil” and “.gov”. More such suffixes will undoubtedly be created.

The Content for Figurative and Trivia is not limited to the WWW, and can be implemented on internet sites without the WWW. It can also utilize and be implemented on internet/television hybrids (not shown).

The Content for Figurative and Trivia can be implemented on intranet websites. The following definition of the intranet is from the Dictionary of Computer and Internet Terms. It defines the intranet as, “the opposite of INTERNET, a network confined to a single organization (but not necessarily to a single site). Intranets often include web pages, so a web browser can be used to view the content. This makes the intranet appear just the same as part of the World Wide Web, the only difference is that it is not accessible to those outside the organization. Keeping it separate from the outside world is essential if it carries confidential data, such as internal business records.”

However, it must be re-emphasized that the Content for Figurative and Trivia is also applicable to computers and software applications that are independent or offline of the internet and the intranet.

The Content for Figurative and Trivia is not limited as to the type of computer on which it runs, and not limited as to the type of network used. This concludes the basic description of the computer hardware, the internet, and the intranet.

Next is a static description of the figurative expressions. The following definitions of figurative are from the Webster's New Collegiate Dictionary. It defines figurative as “representing by a figure or resemblance”, “expressing one thing in terms normally denoting another with which it may be regarded as analogous”, and “characterized by figures of speech”.

The figurative expressions include other nonliteral and wordplay terms or expressions.

Some brand name dictionaries may have nonliteral as a main entry but do not have any definitions for it. The best definitions of nonliteral are from the Oxford English Dictionary©. It defines non-literal (nonliteral) as “Not literal (in various senses).”.

The Oxford English Dictionary© defines literal as “c. Of, relating to, or designating the primary, original, or etymological sense of a word, or the exact sense expressed by the actual wording of a phrase or passage, as distinguished from any extended sense, metaphorical meaning, or underlying significance.” It also defines literal as “a. That is (the thing specified) in a real or actual sense, without metaphor, exaggeration, or distortion.”

The wordplay is self-explanatory.

The figurative expressions include and are not limited to metaphors, similes, analogies, figures of speech, symbolisms, allusions, puns, double entendres, euphemisms, onomatopoeias, buzzwords, slangs, jargons, lingos, malapropisms, spoonerisms, anagrams, palindromes, semordnilaps, lexigrams, alphagrams, ambigrams, pangrams, abbreviations or abbreviated terms, acronyms, initials or initialisms, monograms, condensations or condensed terms, cropped words and phrases, clipped words and phrases, and short form words and phrases. These terms and expressions are hereinafter the “figurative expression” and “figurative expressions”.

The Content for Figurative and Trivia is useful wherever figurative expressions are displayed on a screen. The figurative expressions are often displayed within a text or within associated or related information on the screen. The text is a commonplace feature and is not further described.

For the associated information, an example is a medical website displaying varied information. The website shows links, drop-down menus, images, text in 5 separate sections and columns, statistics, 3 search fields, and a video that are shown with the figurative expressions of a malapropism, an analogy, 5 abbreviations, 2 initials, and an acronym.

The figurative expression can indicate that latent pop-up space contents exists for it or is available with a special signaling feature, such as the symbol “♦”, placed on or next to it. To further distinguish the signal, it can be colored red, for instance.

The selection methods are used to choose the figurative expression.

Next is a static description of the pop-up space contents. The at least 1 pop-up space itself need not always be a strictly rectangular or window shape. The pop-up space can take many forms, shapes, and sizes. The pop-up spaces include and is not limited to overlapping pop-up spaces, multiple pop-up spaces, 3 dimensional pop-up spaces, pop-up spaces that look like many images or moving images such as billowy clouds, and the shapes of pop-up spaces that are moving or changing.

The pop-up space can present educational content features that includes and is not limited to what the figurative expression means, the meanings of it, what it is about, what it stands for, what it represents, spells it out, other information, dictionary materials and entries, other reference materials and entries, words, phrases, persons, people, subjects, and visual information such as images and moving images. The pop-up space with its educational content is hereinafter the “pop-up content” and “pop-up contents”.

The pop-up content includes and is not limited to entire sentences, paragraphs, and pages.

The pop-up content includes and is not limited to literary criticisms, literary reviews, literary summaries, criticisms, reviews, summaries, narratives, historical information, symbolic significances, interpretations, reinterpretations, alternative interpretations, revisionist histories, commentaries, motifs, themes, connotations, and to give different perspectives about the figurative expressions.

The pop-up content can present the reference materials of dictionary entries that include and is not limited to main entries, word divisions, functional labels, parts of speech, pronunciations, syllable breaks, variants, definitions, senses, synonyms, antonyms, etymologies, usages, idioms, homographs, suffixes, prefixes, inflected forms, example sentences, and quotations. These are merely the prominent examples of the many entries of a dictionary.

More examples of the dictionary entries are binomials, cognate cross-references, directional cross-references, synonymous cross-references, inflectional cross-references, functional labels, stylistic labels, capitalization labels, subject labels, temporal labels, regional labels, lightface types, major stresses, minor stresses, centered periods, run-on entries, small capitals, usage notes, and verbal illustrations.

The pop-up content can present any other reference materials that include and are not limited to almanacs, encyclopedias, compilations, summaries, reviews, critical reviews, treatises, maps, and directories.

The pop-up content can contain images and visual imagery that convey a meaning for the selected figurative expression, or the other pop-up contents (not shown), or the related trivia (not shown). The images includes and is not limited to drawings, illustrations, pictures, photographs, comics, paintings, charts, maps, diagrams, 3 dimensional images, and digital photographs.

The pop-up content can contain moving, movement, and action images and visual imagery that convey a meaning for the selected figurative expression, or the other pop-up contents (not shown), or the related trivia (not shown). The moving images includes and is not limited to animation, films, movies, videos, cartoons, claymation, stop-action imagery, 3 dimensional works, digital video works, and computer generated images.

The pop-up content can contain images or moving images that include and is not limited to renderings of ideas, concepts, processes, thinking, thoughts, spatial motions, immaterial things, metaphysics, stories, plays, plots, tales, enactments, reenactments, jokes, and tall tales.

The pop-up content can display a behind the scenes commentary about its images or moving images (not shown). The images or moving images can be presented alone or by themselves without the other pop-up contents.

The pop-up space can have a menu with at least two choices or options to present its content and related trivia in an organized manner. Additional or next selections are necessary to choose the choices on the menus. The drag and selection method of a cursor can be used to make a choice. This method selects so the cursor slides from one location to another location to make a selection. The additional menu selection displays the pop-up content and the related trivia.

A sound system can be utilized, such as for the pronunciation of the figurative expressions, pop-up contents, and related trivia. Other sound effects include and are not limited to narrations, voice-overs, and music. The sound effects can be produced by selecting, for example, a speaker icon displayed in the menu or the pop-up content.

Next is a static description of a complementing or complementary related trivia that is presented with the pop-up content. The related trivia is a trivial type of information. While the pop-up content and its educational information such as a definition is highly important with respect to the figurative expressions, the related trivia information is inherently unimportant. Since the related trivia is trivial information, it is non-obvious in contrast to the high-valued educational information. The related trivia does have educational qualities, however trivial.

The trivia can be related to the associated information on a screen, or related to the selected figurative expressions, or related to the pop-up contents such as an etymology or a moving image. The trivia can even be related to the original trivia itself or any other trivia. The complementary related trivia is hereinafter “trivia” unless described otherwise.

The trivia can be presented in the pop-up content, or it can be presented outside of the pop-up content. The examples of the latter includes and is not limited to displaying the trivia next to the selected figurative expression, next to the pop-up content, next to the associated information, next to the text, at the top or bottom of the screen, and in its own pop-up space.

The trivia challenges a person and is engaging and entertaining. The trivia is not only fun but the person may learn something new. The trivia enlivens the dry and boring experience that is often a part of education.

The trivia can be presented in many formats, and includes and is not limited to the following example formats.

One interactive format has a trivia question with multiple choice answers, and when a choice is selected the result is shown. The result is correct or incorrect. Another format has a true or false trivia question, and when one is selected the result is shown. The true or false format can be substituted with a yes or no format or other like formats. Another format has a trivia question, and when an answer is entered into an input field the result is shown.

Another format has a trivia question with a hint feature that can display the hint information, or display variations of a “hint” link that can be selected to show the hint information. Another format has a series of trivia questions and answers, then showing a score result. Another format has a statement, sentence, or incomplete sentence instead of a question.

Another format asks for more than one answer and displays the multiple choice correct answers and at least one incorrect answer. Another format asks for more than one answer and the answers are entered an input field, or typed on the screen. Another format displays trivia information that is non-interactive, or without the response, answer, and input features.

The next feature is a source (not shown) of the pop-up contents and trivia. The sources can be from published or professional reference works that includes and is not limited to figurative expression dictionaries, abbreviation dictionaries, anagram dictionaries, metaphors dictionaries, standard dictionaries, almanacs, encyclopedias, subject oriented encyclopedias, photography encyclopedias, movie encyclopedias, compilations, summaries, reviews, criticisms, treatises, maps, directories, and thesis publications. Any other reference works that are a source of the pop-up contents and trivia can be utilized.

Other sources includes and is not limited to databases, emerging or trending slang, individuals who originated a figurative expression, emerging science, emerging research, and all communications mediums. The communications mediums includes and is not limited to paper, published materials, art works, photography, zoetropes, phonograms, vinyl records, tape cassettes, cassettes, videocassettes, radio, television, movies, electronics, digital media, computers, internets, CDs, DVDs, computer plug-ins, pc cards, and flash cards.

The next source can be extemporaneous, which is productions or works from the ad hoc creativity of people that includes and is not limited to writers, editors, artisans, illustrators, artists, painters, photographers, filmmakers, directors, producers, cameramen, actors, singers, deejays, dancers, and musicians. The different sources can be mixed together in combination.

The pop-up content and the trivia can be shown in large sized font, large sized text, and in enlarged images or moving images (not shown) that are helpful for the visually impaired. For easier viewing, the colors and contrast of the pop-up content and the trivia can be enhanced and adjusted.

A captions or subtitles (not shown) can be displayed which parallel the sound effects of the pop-up content and the trivia that are helpful for the hearing impaired. The captions or subtitles can play whether the sound is on or off. The captions or subtitles can be shown outside of the pop-up content. The examples of this includes and is not limited to displaying them at the bottom of the screen, next to the text, next to the selected figurative expression, next to the associated information on the screen, next to the pop-up content, and next to the trivia.

### Operation

Next is a description of the simple operation of the first embodiment. The process operates when a person selects a figurative expression. This triggers one or more pop-up content that appears nearby, and the complementary trivia is presented.

The pop-up content and the complementary trivia cooperate to make learning about figurative expressions more educating and exciting. The pop-up content and entertaining trivia adds value and increases the popularity of a digital application, digital property, and digital product or service.

It is emphasized that all of the pop-up content features, with the exception of the trivia, are not required to be presented at the same time. The features include those described in the next section on additional embodiments. The features are options that can be presented to best help a person understand, learn, be educated, and be informed about the selected figurative expressions or the other pop-up contents. The features presented can depend, to a large extent, on the age, language, and makeup of an audience. The wishes of writers, directors, artists, editors, producers, executives, advertisers, and other people can be factors.

### Additional Embodiments

An additional embodiment is that the pop-up contents and trivia can be calibrated to a level of difficulty and sophistication with respect to the age of an intended audience (not shown). Some broad categories loosely define the age groups. The categories includes and is not limited to pre-school, elementary school, junior high school, high school, young adults, adults, twenty-something, thirty-something, and seniors audiences.

Another additional embodiment is that the pop-up contents and trivia can be customized to a level of difficulty and sophistication with respect to an intended audience of an occupation (not shown). There are innumerable occupations that include and are not limited to physicians, HVAC professionals, computer programmers, carpenters, airplane pilots, and organic biologists.

Another embodiment is that the pop-up contents and trivia themselves can be selected to trigger their own latent pop-up content or trivia (not shown). These pop-up contents and trivia can have their own distinctive signals to denote that the latent pop-up content or trivia is available. The additional trivia can be unrelated to anything on the screen or it can be related to the associated information on the screen, or related to the selected figurative expressions, or related to the selected pop-up contents or selected trivia, or any other trivia. Theoretically, this embodiment can be repeated indefinitely. However, information overload concerns and space constraints will likely limit this practice to a few times.

Another additional embodiment is that the pop-up content can present figurative expressions that are separate from the selected figurative expression (not shown).

Another additional embodiment is that the text, associated information, and the figurative expressions displayed on the screen are in a different language or dialect than the language or dialect of the pop-up contents and trivia. The different languages can be a translation of each other.

Another additional embodiment is that the pop-up contents and trivia can use at least two different languages from among all the languages of the world, past and present. The at least two different languages can be a translation of one another. The language embodiments benefits a person interested in learning about a different language.

Thus a person learns about figurative expressions in the fast and convenient process. The pop-up content presents at least one of a plethora of the very useful educational features. Furthermore the person is being entertained and challenged by the fun trivia. The advantages of the embodiments are numerous.

### Advantages

A number of advantages of some embodiments of the Content for Figurative and Trivia are:
(a) for figurative expressions on a screen, to display educational content such as the meaning of it, and fun complementary related trivia in a simple, fast, and convenient process;
(b) the examples of figurative expressions are wordplays, metaphors, analogies, double entendres, symbolisms, allusions, puns, slangs, buzzwords, palindromes, lexigrams, abbreviations, and cropped terms;
(c) when a figurative expression is selected, a pop-up space instantly appears nearby that presents the educational content and the trivia;
(d) the pop-up content can present, for example, meanings, reference materials, historical information, alternative interpretations, commentaries, literary criticisms, or summaries about the figurative expression;
(e) the pop-up content can present, for example, dictionary entries such as definitions, senses, syllable breaks, pronunciations, functional labels, parts of speech, synonyms, antonyms, etymologies, variants, usages, idioms, or quotations about the figurative expression;
(f) the pop-up content can contain, for example, images such as pictures, photographs, illustrations, paintings, drawings, comics, charts, maps, or diagrams that convey a meaning for the figurative expression, or the other pop-up contents, or the trivia;
(g) the pop-up content can contain, for example, moving images such as films, videos, digital video works, animation, claymation, stop-action, or cartoons that convey a meaning for the figurative expression, or the other pop-up contents, or the trivia;
(h) a pop-up space has a menu with choices to present the pop-up content and trivia in an organized manner;
(i) when a pop-up content or trivia is selected, to display their own pop-up content or trivia;
(j) a sound system can be utilized, such as for the pronunciation of the figurative expressions, their pop-up contents, or trivia. The examples of other sound effects are narrations, voice-overs, and music;
(k) the captioning of the sound effects, whether the sound system is on or off, can be displayed that are helpful for the hearing impaired;
(l) the pop-up content and trivia can be shown, for example, in large sized font, large sized text, enlarged images, enlarged moving images, or its colors and contrast can be enhanced or adjusted that are helpful for the visually impaired;
(m) the trivia is related to the associated information on a screen, or the selected figurative expressions, or the pop-up contents, or the original trivia itself, or any other trivia;
(n) the challenging trivia can be presented in varied formats, for example, a series of questions and multiple choice answers with a final score;
(o) the pop-up content and entertaining trivia adds value and increases the popularity of a digital product or service;
(p) to calibrate the level of difficulty of the pop-up content and trivia with respect to the age of the intended audience;
(q) to customize the pop-up content and trivia with respect to the occupation of the intended audience;
(r) the language of the text, the associated information, and the figurative expression displayed on the screen is different from the language of the pop-up content and trivia;
(s) the pop-up content and trivia uses at least two different languages; and
(t) the many features of the pop-up content, except for the trivia, are options that can be presented to best assist a person to learn about the figurative expression.

These and other advantages of one or more embodiments are apparent from a consideration of the above description and accompanying drawings.

### CONCLUSION, RAMIFICATIONS, AND SCOPE

Accordingly, the reader will see that a fast convenient way of acquiring an educational content for a figurative expression and a complementary related trivia are provided on a computer screen.

The figurative expressions, for example, are metaphors, wordplays, and cropped terms.

If a person is in the dark about a figurative expression, a pop-up space presenting the educational content will help matters. The educational content can be, for example, what the figurative expression means, reference materials, interpretations, narratives, images, and moving images.

The person simply selects the figurative expression to instantly get the assistance of the pop-up content to understand it. The always popular and fun trivia makes the learning experience more enjoyable.

Although the above description contains many specificities, these should not be construed as limiting the scope of the embodiments, but as merely providing exemplifications of some of the embodiments. Many other variations are possible. For example, instead of limiting the pop-up content to the above described features, a blog, surveys, rating system, feedback function, save function, email function, and social media services can be implemented in or outside of it.

Thus the scope of the embodiments should be determined by the appended claims and their legal equivalents, rather than by the examples given.

I claim:

1. A process, comprising:
(a) providing a computer,
(b) utilizing a figurative expression displayed on a screen and said figurative expression comprising a metaphor, an allusion, or a pun,
(c) implementing at least 1 pop-up space on said screen,
(d) implementing an educational content substantially about said figurative expression, and
(e) enabling a selecting of said figurative expression displayed on said screen which triggers said at least 1 pop-up space substantially presenting said educational content substantially about said figurative expression.

2. The process of claim 1 further including presenting on said screen an interactive complementary trivia substantially related to said figurative expression, said educational content, said interactive complementary trivia, or an associated information on said screen.

3. The process of claim 1 further including presenting on said screen a non-interactive complementary trivia substantially related to said figurative expression, said educational content, said non-interactive complementary trivia, or an associated information on said screen.

4. The process of claim 1 wherein said figurative expression comprising an analogy, a simile, a double entendre, or a symbolism.

5. The process of claim 1 wherein said figurative expression comprising an euphemism, a figure of speech, a malapropism, or a lingo.

6. The process of claim 1 wherein said figurative expression comprising a slang, a jargon, an anagram, or a cropped term.

7. The process of claim 1 wherein said educational content comprising a meaning, a reference material, a commentary, or what a cropped term stands for.

8. The process of claim 1 wherein said educational content comprising an image, a moving image, a picture, or a video.

9. The process of claim 1 further including providing a sound effect comprising a pronunciation, a narration, or a voice-over.

10. A system, comprising:
a computer,
a figurative expression displayed on a screen and said figurative expression is a nonliteral term,
at least 1 pop-up space on said screen,
an educational content substantially about said figurative expression, and
enabling a user to select said figurative expression displayed on said screen which triggers said at least 1 pop-up space substantially presenting said educational content substantially about said figurative expression.

11. The system of claim 10 further including presenting on said screen an interactive or non-interactive complementary trivia substantially related to said figurative expression, said educational content, said interactive or non-interactive complementary trivia, or an associated information on said screen.

12. The system of claim 10 wherein said figurative expression is a metaphor.

13. The system of claim 10 wherein said figurative expression is an allusion.

14. The system of claim 10 wherein said figurative expression is a double entendre.

15. The system of claim 10 wherein said figurative expression is a slang.

16. The system of claim 10 wherein said figurative expression is an anagram.

17. The system of claim 10 wherein said figurative expression is a cropped term.

18. The system of claim 10 wherein said educational content is a reference material.

19. The system of claim 10 wherein said educational content is a dictionary entry.

20. The system of claim 10 wherein said educational content is a visual imagery.
